(19) United States
(12) Patent Application Publication
(10) Pub. No.: US 2009/0258122 A1
(43) Pub. Date: Oct. 15, 2009

(54) Inline antimicrobial lightwave treatment method and apparatus

(76) Inventor: Rong Yan Murphy, Fayetteville, AR (US)

Correspondence Address: HENRY LAW FIRM;Henry Mark Murphey, P.O. BOX 8850, FAYETTEVILLE, AR, 72703, US

(21) Appl. No.: 12/390,194

(22) Filed: Feb. 20, 2009

Related U.S. Application Data
(63) Continuation-in-part of application No. 12/056,176, filed on Mar. 26, 2008.

(51) Int. Cl. A23L 3/28

(52) U.S. Cl. 426/248; 99/451

(57) ABSTRACT

An inline antimicrobial lightwave treatment method and apparatus is provided. The method and related apparatus comprises a conveyor-based transport system that subjects all surfaces of foodstuff moving on a conveyor to a UV-ruby lightwave combination. In the preferred embodiment, the apparatus uses vertically-stacked conveyor belts to conserve floor space in industry food processing applications. The method is capable of realizing greater than 3 log reductions in live microbes in foodstuffs, although the technology may be used in nonfood applications.

### CROSS REFERENCES

This application is a continuation-in-part of U.S. Ser. No. 12/056,176, filed Mar. 26, 2008.

### GOVERNMENTAL RIGHTS

None.

### BACKGROUND OF THE INVENTION

Undercooked or contaminated foodstuff has caused illness since ancient times. Today, a wide variety of food processing techniques are used to reduce the risk of food-borne illness, and these techniques include the time-honored methods of heating, toxic inhibition (smoking, pickling, etc.), dehydration, low temperature inactivation (freezing) in addition to more modern techniques such as oxidation, osmotic inhibition (use of syrups), freeze drying, vacuum packing, canning, bottling, jellying, heat pasteurization, and irradiation. Generally, such processes do not actually sterilize food, as full sterilization adversely affects the taste and quality of final foodstuffs, but instead reduce microbial content and inhibit further microbial growth. Despite the numerous processes available to food manufacturers to reduce microbes in food, the risk of food-borne illness continues and thus remains the focus of continuing research and development.

Although generally preventable, food-borne illness remains a serious problem to food consumers, government, and industry. Over one-quarter of the population of the United States is affected every year by food-borne illnesses; contaminated food has been estimated by the World Health Organization to cause 76 million illnesses in the U.S. each year, including 325,000 cases resulting in hospitalization and 5,000 deaths. In many cases, microbial contamination occurs during handling when preparing food for retail sale. Although sanitation policies have been improving during recent years, it has proven very difficult to eliminate contamination and pathogens associated with preparing, handling, and processing food at an industrial level. For example, Listeria monocytogenes cannot be eliminated from food or food processing environments using present technologies. A survey by USDA-FSIS showed that between 1% and 10% of retail ready-to-eat deli foods were contaminated with L. monocytogenes. The potential contamination of these and other microbes in foodstuff processing environments presents a serious and continuing food safety threat, which has promoted interest in applying non-heat treatment to foods that kills bacteria and preserves food characteristics. Treating cut fruits and vegetables, seafood, cheese, deli food, meat, poultry, and other foodstuff with non-heat antimicrobial alternatives can reduce or eliminate the presence of microbes.

It is known that more preventative approaches to food safety can reduce or eliminate physical, chemical, and biological hazards in food. “Hazard Analysis and Critical Control Points” (“HACCP”) is a systematic approach to the handling, preparation, and storage of food that aims to prevent food-borne illness at its source rather than inspecting finished products. HACCP works by identifying the steps at which contamination of food is known to occur, and then controlling the environment surrounding food products during those steps, i.e., preventing the entry of contaminants into the sealed processing environment. HACCP is not a process to treat contaminated product; rather, HACCP is a testing methodology to ensure that each step in the process is free from contaminants as well as a strict recording system to verify the results. It is an object of the invention to reduce or eliminate food-borne microbes at virtually any or all stages of an industrial foodstuff processing or preparation system.

The prior art in the field of treating industrial foodstuff to minimize or reduce microbes and contaminants varies widely in form and function, but most references report results measured as the reduction of microbial content between two or more assays in units of “logs,” which represents the difference in microbial content between the two assays in terms of orders of magnitude. For example, a commonly sought after and reported goal in the prior art is a reduction by 3 log, which means that the microbial content in a particular sample was reduced by 3 orders of magnitude to 0.1% of its original content. It is thus an object of the invention to utilize an industry standard measurement of effectiveness and to likewise provide for at least a 3 log reduction in microbial content.

Perhaps the oldest approach to eliminating harmful microbes from food is by application of substantial heat. In order to apply sufficient heat, modem industrial processes may use ovens that require batch processing. Other industrial processes may use infrared ovens placed inline within standardized foodstuff preparation processes; these infrared ovens focus substantial heat energy directly at the foodstuff while it is being processed, rather than heating a larger enclosed space. To address the contamination or microbial activity, high heat infrared ovens have been used to kill microbes, even on precooked food immediately prior to packaging. The relatively long wavelength of infrared (“IR”) allows IR to penetrate below the food surface; however, IR also produces substantial heat directly on the surface of the foodstuff, which may negatively impact the desired qualities of food, such as color, taste, and texture. For instance, U.S. Pat. No. 6,780,488, issued to Howard, discloses the use of a specific type of infrared oven in which heating elements surround an inline conveyor and reheat precooked food to 500° C. or more. Again, the problem with reheating precooked food to such high temperatures is that such food invariably continues to cook. Changes to taste and color at such temperatures occur and the outer surface of foodstuff such as meat turns tough and brown. Thus, while infrared may be beneficial in some industrial cooking applications, IR is not particularly well-suited to reheating precooked food to treat it against contamination immediately prior to being packaged. IR is even more detrimental to foodstuffs including fruits, vegetables, or other items that have low tolerances to heat. It is thus an object of the invention to meet or exceed the sanitary achievements surrounding the use of IR while also avoiding the high heat that accompanies the use of IR. It is also an object of the invention to avoid the requirement that the foodstuff be processed in batches but rather to permit the foodstuff to remain part of a continuous processing system.

The industry food processing industry has used ultraviolet light to kill microbes on foodstuff. Ultraviolet light, or UV, is a naturally occurring wavelength of light produced by the sun that partially penetrates the earth's atmosphere in sufficient quantities to have noticeable effects, such as the burning of human skin without heat over a relatively prolonged period of several minutes to a few hours. Similarly, UV is known in the prior art as an effective tool for decreasing the number of living microbes on the surface of some foodstuffs. However, as noted in U.S. Pat. No. 4,396,582 issued to Kodera et al., a known problem with UV is that for it to be effective as an anti-microbial agent, the food surface must have direct contact with UV treatment. Because UV is incapable of appreciable penetration into food products, it is also not a good tool to reduce microbes located anywhere but the surface of the food product. Further, if any packaging or other material is located between the UV source and the food surface, the effectiveness of UV on the food surface is greatly reduced. It is therefore an object of the invention to address the historical inadequacies associated with using UV as an antimicrobial treatment for industrial foodstuff, especially for food products that have already been processed and packaged and are being readied for sale.

It is a further object of the invention to disclose new methods of non-thermal or low-thermal anti-microbial treatment that hold significant promise for reducing or eliminating microbes from solid and semisolid materials.

Deficiencies of sterilization techniques plague other industries as well, particularly the medical field. Accordingly, it is a further object of the invention to apply to industries in which sterilized items, whether solid and semisolid materials, are desirable.

The process, as well as the apparatus in accordance with the invention, provides reliable and relatively inexpensive non-thermal pasteurization and anti-microbial treatment of solid and semisolid materials.

### BRIEF SUMMARY OF THE INVENTION

This inline antimicrobial lightwave treatment process and related apparatus solves many different problems of microbial contaminations in solid and semisolid materials. The process and apparatus of this invention can be used with solid and semisolid materials before, during, or after processing or packaging. Specifically, the invention comprises an inline treatment device designed to utilize a novel combination of various wavelengths of electromagnetic radiation to kill microbes on food.

Generally, inline manufacturing processing of solid food involves a series of conveyors that transport solid foodstuff at a predetermined velocity and inter-spacing to allow for adequate inspection and packaging. Solid foodstuff processing continues uninterrupted until such time as it is desirable to treat the foodstuff with an antimicrobial treatment; in prior art applications using heat, for instance, the inline conveyor system may need to have been interrupted to apply batch antimicrobial heat treatments in an oven. In contrast to the prior art, the invention is useful for inline solid and semisolid food conveyor systems in that the invention contemplates antimicrobial treatment as a component of the inline conveyor system rather than a separate, batch-type component.

The use of lightwave energy applies to the treatment of both solid and semisolid food. The apparatus subjects microbes to novel combinations of light waves, i.e., the combination of visible red light (“ruby light”) and UV light in order to achieve a proper reduction in the microbe population of a given foodstuff. The invention uses UV light having a wavelength between about 10 nanometers (nm) and 400 nm and ruby light at a wavelength between about 560 nm and 1,000 nm, and the invention harnesses constructive interference between these wavelengths of light. This phenomenon occurs when the two different wavelengths of light interfere, and the result is substantially deeper penetration of the short-wavelength UV light beyond the food surface and into the actual foodstuff. Such embodiment is particularly effective over the prior art when used in connection with prepackaged foodstuffs. That is, the combination of ruby light with UV light energy overcomes the limitations associated with the use of UV light alone by penetrating many forms of plastic packaging. This advance is even more effective than the prior art at penetrating dark plastic packaging. Further, by using ruby light rather than infrared radiation, the radiated heat generated by the process is much lower, thereby decreasing the amount of heat applied to the food in furtherance of one object of the invention.

### BRIEF DESCRIPTION OF THE DRAWINGS

FIG. 1 is a perspective view of the inline antimicrobial lightwave treatment apparatus.

FIG. 2 is a side view of the inline antimicrobial lightwave treatment apparatus.

FIG. 3 is a perspective view of the light bank utilized in the inline antimicrobial lightwave treatment apparatus.

FIG. 4 is a cut-away view of the light bank along the line 4-4 in FIG. 3.

FIG. 5 is a side view of the ruby bulb utilized in the inline antimicrobial lightwave treatment apparatus.

These and other advantages of the invention will become apparent from the following detailed description which, when viewed in light of the accompanying drawings, discloses the invention.

### LISTING OF COMPONENTS

101—lightwave apparatus
103—conveyor belt
105—hangers
107—light banks
109—bulbs
111—power gears
113—conveyor gears
115—chains
117—idler pulleys
119—slide
121—shield
123—chute
125—chute adjustment means
127—light bank housing
129—filament
131—glass tube
133—opaque material

### DETAILED DESCRIPTION OF THE INVENTION

The invention is an inline antimicrobial lightwave treatment method and apparatus designed for use in industrial food processing facilities and incorporates by reference the specification of U.S. Ser. No. 12/056,176, filed Mar. 26, 2008. Typical food processing facilities utilize food transport systems to move foodstuffs along various processing stations so that the foodstuff may be continually processed from raw goods to finished and/or packaged products. Food transport systems are often conveyor-based for solid, prepackaged, and semi-solid foods. In connection with industrial processing, the foodstuff may be contaminated by microbes that may be inherent to the foodstuff or is a residue of the processing system. Food processing systems are generally prone to microbial growth.

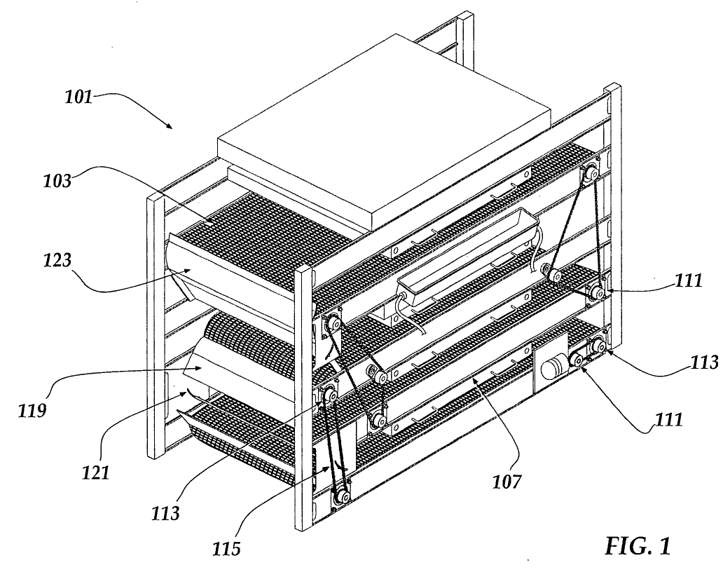

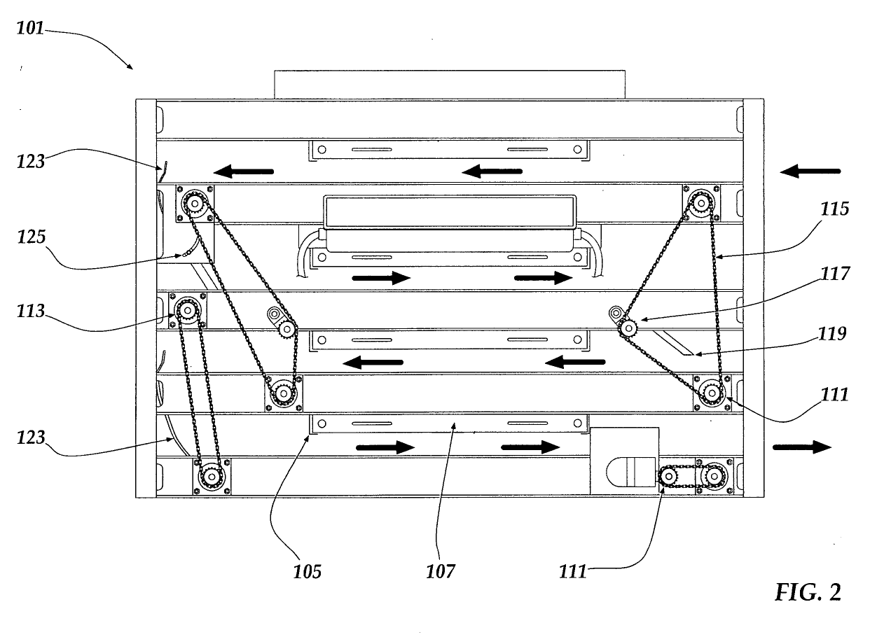

FIGS. 1 and 2 show an inline processing station for solid foodstuff, which generally comprises a lightwave apparatus 101 through which foodstuff from a food transport system travels in the direction of the thick arrows (shown in FIG. 2), subjects the foodstuff to antimicrobial treatment, and permits the foodstuff to be transported uninterrupted through the continuous food transport system. Lightwave apparatus 101 utilizes a conveyor belt 103, which transports foodstuff to and through lightwave apparatus 101. In typical industrial situations, foodstuff can move along conveyor at approximately 120 pounds per minute (lbs/min), and lightwave apparatus 101 is preferably constructed to handle foodstuff moving at up to 160 lbs/min.

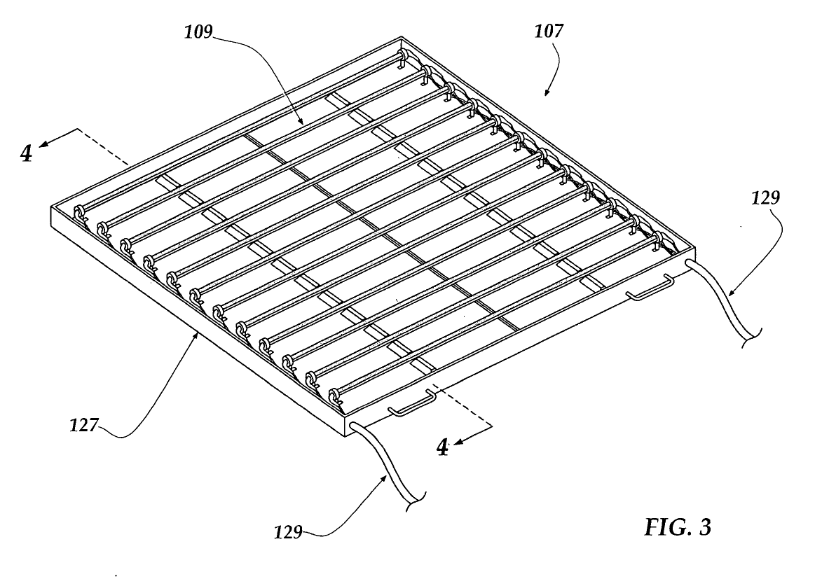

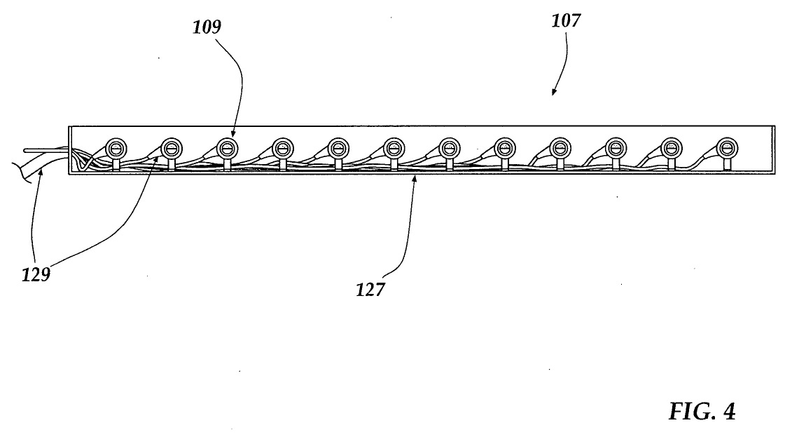

Lightwave apparatus 101 has hangers 105 designed to receive light banks 107, which secure a combination of ruby and UV light bulbs 109 (shown in FIGS. 3-4) that generate the electromagnetic energy to kill microbes. Slides 105 preferably comprise a C-shaped channel that extends the width of lightwave apparatus 101, and which engage the outer housing of light banks 107. Light banks 107 shine electromagnetic radiation onto foodstuff passing under light bank 107 on conveyor belts 103.

Lightwave apparatus 101 is preferably designed to minimize floor space necessary to house lightwave apparatus 101 by using multiple conveyor belts 103 in a vertical column. Conveyor belts 103 are moved using one or more power gears 111, which rotate and transfer power to conveyor gears 113 using chains 115. Each conveyor belt 103 is turned by a conveyor gear 113, and each conveyor gear 113 preferably has a 1:1 gear ratio with respect to all other conveyor gears 113 to allow synchronous movement between the conveyor belts 103 that comprise lightwave apparatus 101. In some applications, however, a speed increase between each conveyor belt 103 and the adjacent conveyor belt 103 below may be ideal, such as when the lightwave apparatus 101 is utilized as a station in an conveyor-based food processing system in which the different components move at different speeds. In such cases, the gear ratios between the power gears 111 and conveyor gears 113 will determine the speeds of the conveyors according to known methods. Idler pulleys 117 may be utilized to maintain tension on chains 115.

As foodstuff moves on conveyor belts 103, foodstuff is transferred from conveyor belts 103 higher on lightwave apparatus 101 to conveyor belts 103 lower on lightwave apparatus 101. Immediately adjacent conveyor belts 103 move in opposite directions; conveyor belts 103 that move in the same direction are connected together using chains 115. With appropriate gearing, one power gear 111 may be sufficient to drive conveyor belts 103. However, it is preferred that at least two power gears 111 are required, one for each direction of travel of conveyor belts 103.

The transfer between adjacent conveyor belts 103 may be performed in two manners. First, if it is desired that the side of foodstuff facing upwards remain facing upwards, the food is “dropped” on a slide 119, which deposit food in the same orientation on the adjacent conveyor belt 103 below. Shield 121 prevents food from accidentally falling off conveyor belts 103. Second, if it is desired that the side of foodstuff facing downwards will face upwards after the transfer, the food is “flipped” using a chute 123. Depending on the size and shape of the foodstuff, chute 123 may require an optional chute adjustment means 125.

Preferably, the top and bottom surface of foodstuff is subjected to lightwave treatment for an equal amount of time, which requires an appropriate combination of flips and drops. For instance, FIGS. 1 and 2 demonstrate an implementation of lightwave apparatus 101 that has four conveyor belts 103. At the end of the topmost conveyor belt 103, foodstuff is flipped onto second highest conveyor belt 103 to expose the bottom of foodstuff to lightwave treatment from light banks 107. Foodstuff is then dropped onto the third highest conveyor belt 103 to continue to expose the bottom of foodstuff to lightwave treatment from light banks 107. Finally, foodstuff is flipped again to expose the top of foodstuff to the final lightwave treatment.

The preferred embodiment uses lightwave energy for the antimicrobial treatment of solid or semisolid foodstuff. Referring now to FIGS. 3-4, the preferred embodiment uses a light bank 107 that has one or more bulbs 109 secured in a light bank housing 127 and powered using power lines 129. Bulbs 109 are of two kinds: one type of bulb 109 produces ruby light, and the other type of bulb 109 produces UV light. Thus, foodstuff traveling along conveyor 103 is effectively bathed in a combination of UV and ruby light. Preferably, the preferred embodiment ensures that a sufficient surface of foodstuff traveling on conveyor 103 receives a sufficient amount UV and ruby light to effectively treat against microbes. Conveyor 103 may also be constructed of a material or designed in a way that minimizes interference with or scattering of UV light to ensure an effective treatment of the foodstuff with UV and ruby light while the foodstuff is traveling along conveyor 103. For example, conveyor 103 may preferably be made of fine stainless steel mesh, quartz glass rods, a transparent plastic mesh, or cloth fiber materials.

In the preferred embodiment, food is simultaneously exposed to UV light between about 10 nanometers (nm) and 400 nm and ruby light at a wavelength between about 560 nm and 1,000 nm. UV light at such wavelengths, and particularly at wavelengths at about 250 to 260 nm, inactivates microbes. When used in conjunction with UV light, ruby light assists UV light in penetrating food packaging and the surface of food products.

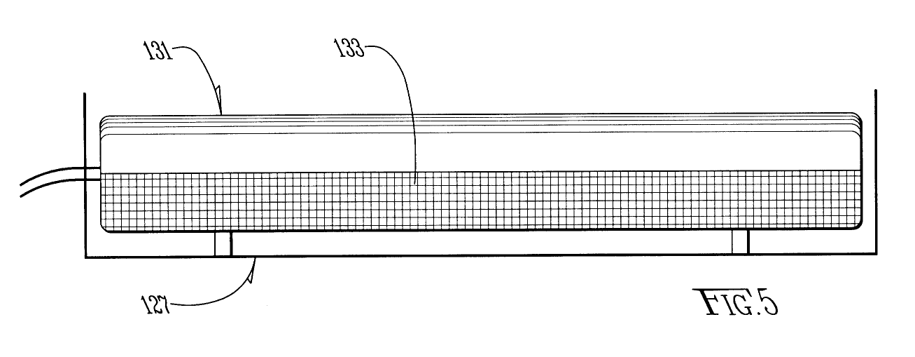

While UV bulbs 109 are known in the art, ruby bulbs 109 may be constructed using a novel construction method as shown in FIG. 5. Ruby bulbs 109 are preferably constructed by enclosing a filament 129 (not shown) in a glass tube 131. Glass tube 131 is preferably made of high quality silica or quartz glass. Glass tube 131 is plated with opaque material 133 that permits control over the direction and intensity of ruby light emitted by ruby bulbs 109. Preferably, opaque material 133 comprises a heavy, reflective metal such as gold so that light striking opaque material 133 is reflected until it exits glass tube 131. The use of a heavy, reflective metal such as gold for opaque material 133 substantially eliminates the problem of wasted energy due to absorption of light as heat by opaque material 133. While the ruby bulb 109 is shown in FIG. 5 as having a shape similar to light bulbs of the prior art, no such limitation is intended.

Persons having ordinary skill in the art will recognize that the modularity of lightwave apparatus 101 makes it well suited for use in multiple locations throughout a food processing system. Oftentimes, food processing systems involve repeated heating and cooling of food for various purposes, i.e., pasteurization, cooking, dethawing, etc. Several times during processing, food may pass through temperatures ranging from −2° C. to 55° C., which are conducive to microbial growth. Upon exiting such temperature ranges, particularly on the low side of such ranges, it is advantageous to use lightwave apparatus 101 to remove microbes from the foodstuff. Lightwave apparatus 101 may be used at virtually any temperature, but are preferentially used between about −25° C. and 80° C. This range is larger than the microbial growth range, which demonstrates that it may be advantageous to administer an antimicrobial treatment in a temperature environment in which the microbes are inactive and microbial growth is virtually zero.

In the preferred embodiment, lightwave apparatus 101 is scalable to treat solid foodstuff traveling on conveyor 103 at rates up to about 160 lb/min simply by altering the amount of power applied to the bulbs used in lightwave apparatus 101, if desired. By increasing the width and/or speed of conveyor 103 and the power capable of being applied to the energy system installed in lightwave apparatus 101, persons skilled in the art will recognize that lightwave apparatus 101 is scalable to handle foodstuffs traveling at far greater rates than 160 lb/min.

The inventor has realized 3 log up to 9 log reductions in microbes on food by utilizing the lightwave treatment methods disclosed herein. Additional benefits of using the preferred embodiment disclosed herein include antimicrobial treatment without interrupting existing processing line speeds; the ability to treat packaged food; extending shelf life on packaged foodstuffs; no substantial pressure or temperature increase due to treatment; and the flexibility to be adapted to virtually any preexisting food processing or other product automated or semi-automated operation.

The preferred embodiment of the invention is designed for industrial food processing facilities but may be used in conjunction with standardized processing of other materials and products other than foodstuff.

While the inventor has described above what she believes to be the preferred embodiment of the invention, persons having ordinary skill in the art will recognize that other and additional changes may be made in conformance with the spirit of the invention and the inventor intends to claim all such changes as may fall within the scope of the invention.

I claim:

1 A food processing apparatus, comprising:
One or more conveyors for transporting foodstuff;
A light bank having one or more ultraviolet bulbs capable of producing ultraviolet light having a wavelength between about 10 nanometers and 400 nanometers and one or more ruby light bulbs capable of producing ruby light having a wavelength between about 560 nanometers and 1,000 nanometers, thereby causing a reduction in live microbial content, wherein the ultraviolet and ruby light is directed towards the one or more conveyors.

2. An antimicrobial treatment method comprising delivering an effective amount of light energy, said light energy consisting of the combination of ultraviolet light having wavelength between about 10 nanometers and 400 nanometers and ruby light having wavelength between about 560 nanometers and 1,000 nanometers, thereby causing a reduction in live microbial content.

3. The antimicrobial treatment method of claim 2 wherein the effective amount of light energy is delivered during transport along a conveyor system.
